(19) United States
(12) Patent Application Publication
(10) Pub. No.: US 2026/0264031 A1
(43) Pub. Date: Sep. 10, 2026

(54) SYSTEMS AND METHODS FOR DISTRIBUTING FOOD INGREDIENTS

(71) Applicant: Server Products, Inc., Richfield, WI (US)

(72) Inventors: Steven J. Ennesser, Mequon, WI (US); Jordan W. Nielsen, Mayville, WI (US); Thomas J. Reiss, III, West Allis, WI (US)

(21) Appl. No.: 18/878,369

(22) PCT Filed: Jun. 29, 2023
(86) PCT No.: PCT/US2023/069339

§ 371 Date: Dec. 23, 2024

Related U.S. Application Data
(60) Provisional application No. 63/356,706, filed on Jun. 29, 2022.

(51) Int. Cl. B01F 33/84; A23L 23/00; B01F 31/20; B01F 35/22; B01F 35/221; B01F 35/71; B01F 101/06

(52) U.S. Cl. CPC B01F 33/846; B01F 31/26; B01F 35/2209; B01F 35/2211; B01F 35/712; B01F 35/7176; B01F 35/7179; A23L 23/00; B01F 2101/06

(57) ABSTRACT

A system and method are provided for distributing a first food ingredient across a second food ingredient. The system includes a base unit configured to receive a container configured to receive a first food ingredient for distribution onto the second food ingredient. The base unit includes a drive motor coupled to a drive shaft to rotate about a vertical rotation axis and a support surface coupled to the drive shaft to rotate about the vertical axis and configured to engage the container to the base unit at an angle that is non-transverse to the vertical axis. The base unit also includes a magnet configured to secure the container to the support surface as the support surface is rotated by the drive motor via the drive shaft to rotate about the vertical axis. A control unit is configured to control the base unit cause the drive motor to rotate the support surface to distribute the first food ingredient across the second food ingredient.

### CROSS-REFERENCE

The present invention is based on, claims priority to, and incorporates herein by reference U.S. Provisional Patent Application Ser. No. 63/356,706, filed Jun. 29, 2022.

### BACKGROUND

The present disclosure relates to systems and methods for distributing food ingredients during a food-preparation process. More particularly, the present disclosure provides systems and methods to control a dispenser to dispense a first food ingredient based on a type of the first food ingredient or a quantity of a second food ingredient or to control a base unit to rotationally distribute the first food ingredient across the second food ingredient.

Food items or ingredients are often combined in food preparation processes. Many food preparation processes seek to distribute a sauce over another food product. For example, food ingredients such as bone-in chicken wings, boneless chicken wings, deep fried cauliflower, and many others are often coated with one or more sauces as part of the food preparation process. Other types of food items, such as a salad or anything else that may require a sauce or other coating are similarly prepared without the sauce or coating and then need to have the sauce or coating applied as part of the preparation process. In many restaurants, food ingredients are placed in a large bowl and a worker pours or otherwise dispenses a sauce, dressing, or coating onto the food item(s) in the bowl. The worker must then manually shake the bowl to cause the food item to tumble/mix in the bowl to evenly distribute the sauce over all of the food items.

Manually mixing food ingredients consumes the time of skilled workers because mixing may require workers to shake or tumble the food items over a lengthy period of time to ensure that the sauce, dressing, or coating covers all of the food items in a consistent manner. In some cases, the manual mixing of the sauce may not evenly cover the food item, leading to inconsistent preparation of food. Furthermore, overly vigorous mechanical shaking and stirring of the bowl by workers can cause food ingredients, such as breading on breaded food items (e.g., boneless wings or breaded vegetables), to fall off of the food item, resulting in an undesirable completed product.

Thus, there is a need to improve the mixing or other distribution of a food ingredient, such as a sauce, onto another food ingredient.

### SUMMARY

The present disclosure relates to the distribution of a first food ingredient with another food ingredient. In one non-limiting example, the first food ingredient may include a sauce such that the systems and methods provided herein serve to effectuate the coating of a sauce or dressing onto the second ingredient or combination of food items or ingredients. Systems and methods are provided for automating the coating of sauces that provide a more consistent completed food product, while increasing the efficiency of kitchen staff, by reducing the amount of time a cook must interact with a food item. Such automated systems and methods may further eliminate the need for experienced or highly trained kitchen workers for the process of saucing or otherwise distributing food ingredients, while allowing for more consistent preparation of the food ingredients or items to standards maintained by the restaurant or other food service facility. In one non-limiting example, a food spinning/mixing is provided device that can be used to distribute a sauce onto a food ingredient or item, such as chicken wings, other fried foods, salads, or another food item.

In accordance with one aspect of the disclosure, a system is provided for distributing a first food ingredient across a second food ingredient. The system includes at least one dispenser configured to dispense the first food ingredient and a base unit configured to receive a container having the second food ingredient arranged therein in a position to receive the first food ingredient from the at least one dispenser. The base unit includes a support surface configured to engage the container to the base unit and a drive motor coupled to the support surface to rotate the support surface about a vertical rotation axis. The system also includes a control unit configured to control at least one of (i) the at least one dispenser to dispense the first food ingredient based on at least one of a type of the first food ingredient or a quantity of the second food ingredient or (ii) the base unit to cause the drive motor to rotate the support surface to distribute the first food ingredient across the second food ingredient.

In accordance with another aspect of the disclosure, a system is provided for distributing a first food ingredient across a second food ingredient. The system includes a base unit configured to receive a container configured to receive a first food ingredient for distribution onto the second food ingredient. The base unit includes a drive motor coupled to a drive shaft to rotate about a vertical rotation axis, a support surface coupled to the drive shaft to rotate about the vertical axis and configured to engage the container to the base unit at an angle that is non-transverse to the vertical axis, and a magnet configured to secure the container to the support surface as the support surface is rotated by the drive motor via the drive shaft to rotate about the vertical axis. The system further includes a control unit configured to control the base unit cause the drive motor to rotate the support surface to distribute the first food ingredient across the second food ingredients.

In accordance with yet another aspect of the disclosure, a system is provided for distributing a first food ingredient across a second food ingredient. The system includes at least one dispenser configured to dispense the first food ingredient, a container configured to receive the first food ingredient from the at least one dispenser and the second food ingredient, and a base unit configured to position the container to receive the first food ingredient from the at least one dispenser. The base unit includes a drive motor coupled to a drive shaft to rotate about a vertical rotation axis, a support surface coupled to the drive shaft to rotate about the vertical axis and configured to engage the container to the base unit at an angle that is non-transverse to the vertical axis, and a magnet configured to secure the container to the support surface as the support surface is rotated by the drive motor via the drive shaft to rotate about the vertical axis. The system further includes a control unit configured to control at least one of (i) the at least one dispenser to dispense the first food ingredient based on at least one of a type of the first food ingredient or a quantity of the second food ingredient or (ii) the base unit cause the drive motor to rotate the support surface to distribute the first food ingredient across the second food ingredient

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure.

FIG. 1 is a side view of a dispensing system according to one non-limiting configuration of the present disclosure.

FIG. 2 is a schematic of the dispensing system of FIG. 1.

FIG. 3 is a perspective view of a docking station for use with the dispensing system of FIG. 1.

FIG. 4 is a bottom perspective view of a base unit of the base unit of the dispensing system of FIG. 1.

FIG. 5 is a transparent side view of the base unit of the dispensing system of FIG. 1.

FIG. 6 is a side view of the base unit of the dispensing system of FIG. 1.

FIG. 7 is a plan view of a support platform of the dispensing system of FIG. 1.

FIG. 8 is a perspective view of the support platform of the dispensing system of FIG. 1.

FIG. 9 is a side view of the support platform of the dispensing system of FIG. 1;

FIG. 10 is a bottom perspective view of the support platform of the dispensing system of FIG. 1.

FIG. 11 is a perspective view of a dispensing system including an array of dispensers according to a configuration of the present disclosure.

FIG. 12 is a front view of the dispensing system of FIG. 10.

FIG. 13 is a schematic of a dispensing system according to a configuration of the present disclosure.

### DETAILED DESCRIPTION

In accordance with various non-limiting examples, systems and methods for distributing a food ingredient or item with another food ingredient(s) or item(s) are described herein. In accordance with various non-limiting examples, systems and methods for coating a food item with a dressing or sauce are provided that can decrease a manual workload on kitchen staff preparing the food item, while also allowing for more consistent coating and preparation of the food item.

In some non-limiting examples, the present disclosure provides a system or device for coating a food item with a sauce. More specifically, the present disclosure relates to a system, that can receive a food ingredient or item (such as prepared chicken wings) in a bowl or container and mix or tumble the food item to distribute the sauce evenly onto the food item. As will be described, the device utilizes a motor to rotate a support member that in turn supports a bowl or other container. The support member is designed such that rotation of the motor causes the food items to mix in the container to distribute the sauce consistently over the food items. The support member is shaped, such that a rotation of the support member causes a nutating movement of the container, to evenly coat the food items with sauce. Although nutating movement is shown and described, other movements to mix a food item, such as spinning or rotating on a vertical or angled axis are also contemplated. In some non-limiting examples, the base unit may be coupled to a docking station that supports one or more dispensers that pump or otherwise introduce sauce or dressing into the container.

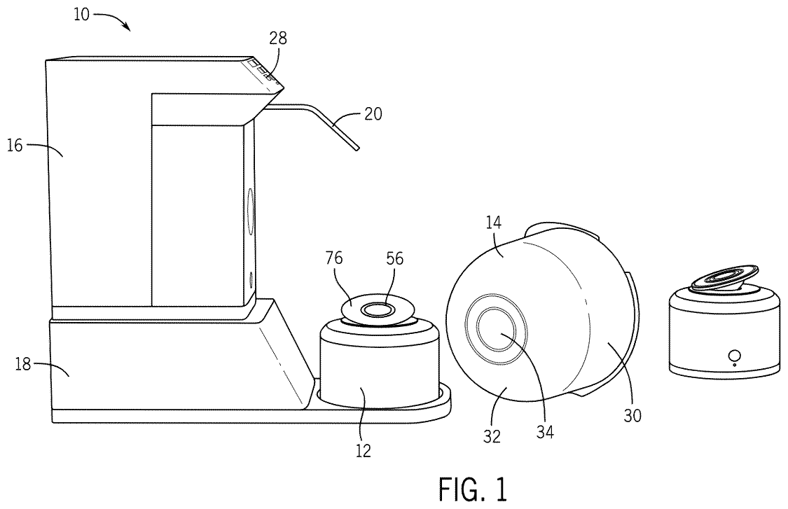

FIG. 1 illustrates an example system 10 for dispensing a first food ingredient (e.g., a sauce, dressing, topping or other liquid or non-liquid food product) onto a second food ingredient (e.g., boneless wings, bone in wings, vegetable wings, salads, or other food items mixed with sauce). As described below, the system 10 is configured to automate the dispensing and even coating of the first food ingredient onto the second food ingredient.

Referring still to FIG. 1, the system 10 includes a base unit 12 for nutating a container 14 to mix food ingredients, a dispenser 16 for dispensing the first food ingredient, and a docking station 18 that supports the dispenser 16. In some configurations, the base unit 12 and the container 14 can be operated to mix the first food ingredient and the second food ingredient without the dispenser 16 and the docking station 18 or with different dispensers.

The dispenser 16 includes an internal supply of the first food ingredient. The first food ingredient is configured to be pumped or otherwise caused to move through a spout 20 that extends from the supply of the first food ingredient, toward the base unit 12. The first food ingredient in the internal supply of the dispenser 16 can be contained within a removable receptacle or bag such that the first food ingredient can be replenished when the supply has been depleted during use.

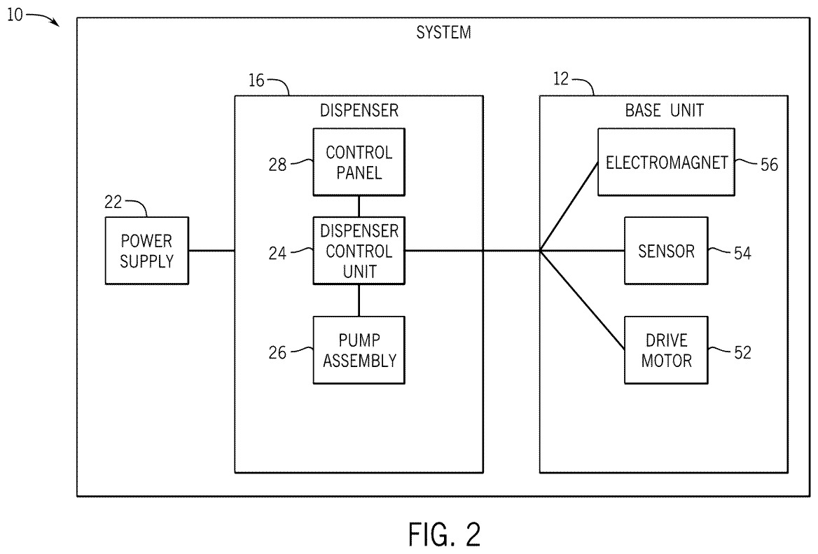

As illustrated in the schematic of FIG. 2, the dispenser 16 may be connected to a power supply 22 that is configured to power a control unit 24 and a pump assembly 26. The pump assembly 26 may be configured to pump the first food ingredient through the dispensing spout 20 into the container 14. The control unit 24 of the dispenser 16 may include a wireless communication device to allow for firmware updates, programming, or integration with other nearby devices, such as other dispensers.

Referring again to FIG. 1, in some configurations, the dispenser 16 may include a control panel 28. The control panel 28 (e.g., a touch-screen display or buttons) may include an optional user interface to allow a worker to select a quantity of the first food ingredient to be dispensed. As described further below, the pump assembly 26 may pump a quantity of the first food ingredient based on an input to the control panel 28 specifying a volume of the first food ingredient, an order size, and/or a first food ingredient type. In some configurations, the control panel 28 may also provide an “auto” option, that allows the system 10 to automatically determine an amount of the first food ingredient that may be needed based on an amount of the second food ingredient present in the container 14.

Referring still to FIG. 1, the container 14 may include one or more sidewalls 30 extending upward from a container base 32. A top of the container 14 may be open, configured to receive the first food ingredient and the second food ingredient. In some configurations, the container 14 may further include a lid (not shown) to avoid spillage of the food ingredients. In some configurations, the sidewalls 30 may be designed to ensure that the food ingredients may not be spilled during nutation of the container 14.

In some configurations, the container 14 may include a ferromagnetic plate 34 or other magnetically interactive material secured to a bottom of the container 14. As described further below, the ferromagnetic plate 34 may allow the container 14 to be removably coupled to the base unit 12. The ferromagnetic plate 34 may be attached to the container 14 or may be integrally formed with the container 14, including forming the entire container 14 of a ferromagnetic material. The ferromagnetic plate 34 that is attached to the bottom of the container 14, may allow kitchen workers to modify a pre-existing container in the kitchen, ultimately reducing initial implementation costs and presenting a well-known container to the kitchen workers.

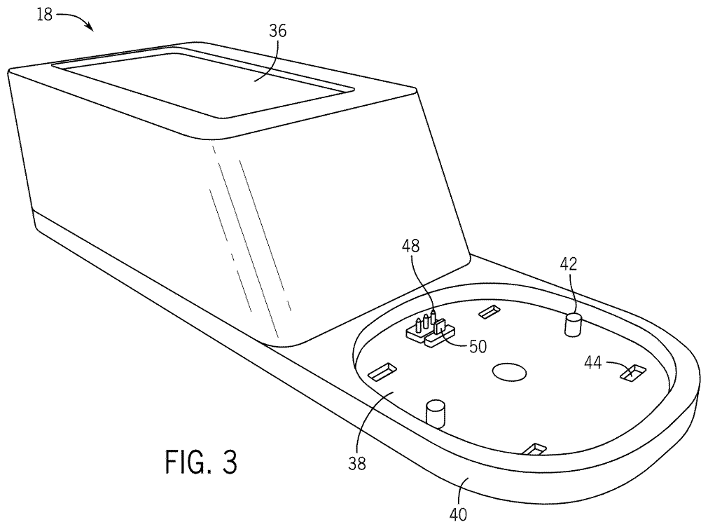

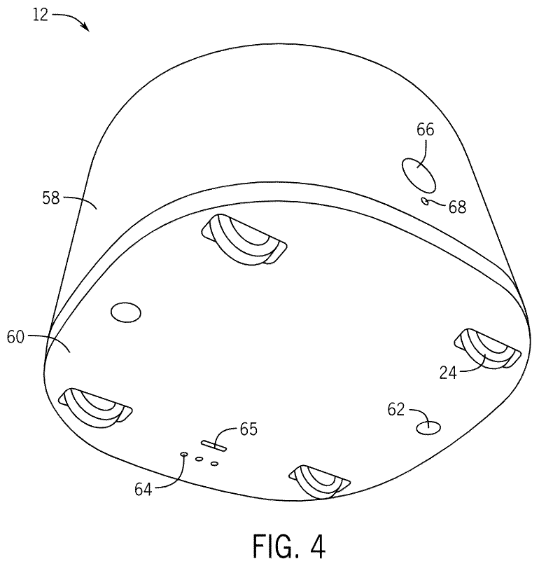

Referring now to FIG. 3, in some configurations the docking station 18 is configured to support the base unit 12 and the dispenser 16. The docking station 18 may be sized to provide a standoff height for the dispenser 16 such that the container 14 can be properly supported by the base unit 12 below the dispensing spout 20. In some configurations, the docking station 18 includes a first recess 36, disposed on a top of the docking station 18, that is sized to receive and retain the dispenser 16. The docking station 18 may further include a second recess 38, disposed on a platform 40 extending from a bottom of the docking station 18, that is sized to receive and retain the base unit 12. The first recess 36 and the second recess 38 may be vertically separated by the standoff height. The second recess 38 may include a pair of alignment bosses 42 that are used to properly align the base unit 12 when the base unit 12 is received on the platform 40. The second recess 38 may further include a series of wheel receptacles 44 that are spaced to receive wheels 46 (see FIG. 4) on a bottom surface of the base unit 12. The alignment bosses 42 and the wheel receptacles 44 may help to prevent or mitigate movement of the base unit 12 within the second recess 38 during operation.

In some configurations, the second recess 38 includes a series of power supply pins 48 and a data port 50. The data port 50 may be a USB connector or any other type of connector that allows data to pass from the dispenser 16 to the base unit 12. The data port 50 may allow data communication between the components of the base unit 12 (e.g., a drive motor 52, a sensor 54, and an electromagnet 56, see FIG. 2) and the control unit 24. The power supply pins 48 may provide power from the power supply 22 to the base unit 12.

The base unit 12 of the system 10 that includes both the base unit 12 and the dispenser 16, may not include a base control unit (not shown), as the controller of the dispenser 16 can power and control the operation of the base unit 12 through the power and communication connections. In a configuration in which the base unit 12 is used on its own without the dispenser 16, a control unit and a power supply may be disposed within the base unit 12 to power and control the components of the base unit 12.

Referring to FIGS. 4-6, the base unit 12 includes a housing 58 that is connected to a housing bottom 60. In some configurations, the housing bottom 60 may include the wheels 46 that allow the base unit 12 to move along a counter or other flat surface. In some configurations, the housing bottom 60 may include other types of supports, such as legs, that may prevent movement of the base unit 12 during the mixing operation. The housing bottom 60 may further include a pair of alignment holes 62 that are sized to receive the bosses 42 disposed in the second recess 38. The housing bottom 60 may also include one or more pin receptacles 64 and a data receiving slot 65 that are spaced and located to receive the power supply pins 48 and the data port 50 disposed in the second recess 38.

Still referring to FIGS. 4-6, the housing 58 may include a power button 66 and an indicator light 68. In some configurations, the power button 66 may be disposed on a front of the housing 58, to provide workers unhindered access to depress or otherwise activate the power button 66. In some configurations, the power button 66 may be used to begin a mixing function of the base unit 12. In some configurations, the power button 66 may be configured to send a signal to the control unit 24 to activate a function of the system 10.

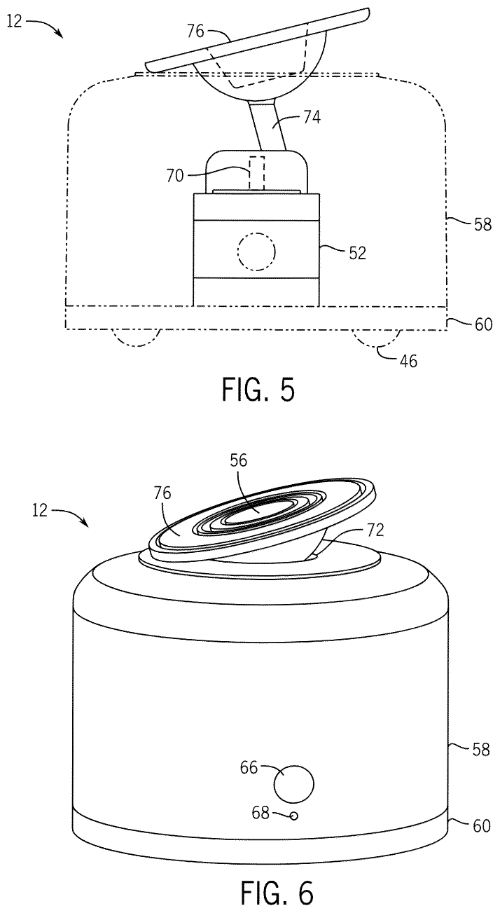

FIG. 5 is a transparent illustration of the base unit 12, showcasing an example configuration of the components therein. In some configurations, the base unit 12 includes the drive motor 52, disposed within the housing 58. The drive motor 52 may include a drive shaft 70 extending upward from the drive motor 52. The drive motor 52 may be an electric motor that may be controlled by the control unit 24 of the dispenser 16 through the aforementioned data connections. The drive motor 52 may include one or more gear reducers or increasers to increase or decrease a speed at which the drive motor 52 may rotate the drive shaft 70. In some configurations, one or more gears within the drive motor 52 may be non-circular, leading to variable rotation speed of the drive shaft 70.

As illustrated in the schematic of FIG. 2, in some configurations, the base unit 12 may further include the sensor 54. As described further below, the sensor 54 may be configured to sense a presence of the container 14 and/or an amount of the first food ingredient or second food ingredient disposed in the container 14. Also as described further below, the base unit 12 may be configured to couple the container 14 using the electromagnet 56. In some configurations, the housing 58 may include the internal operation components to control delivery of power to the electromagnet 56. In the system 10 that includes both the dispenser 16 and the base unit 12, the activation of the electromagnet 56 may be controlled by the control unit 24 of the dispenser 16. In the system 10 that does not include the base unit, the activation of the electromagnet 56 may be controlled by the base control unit.

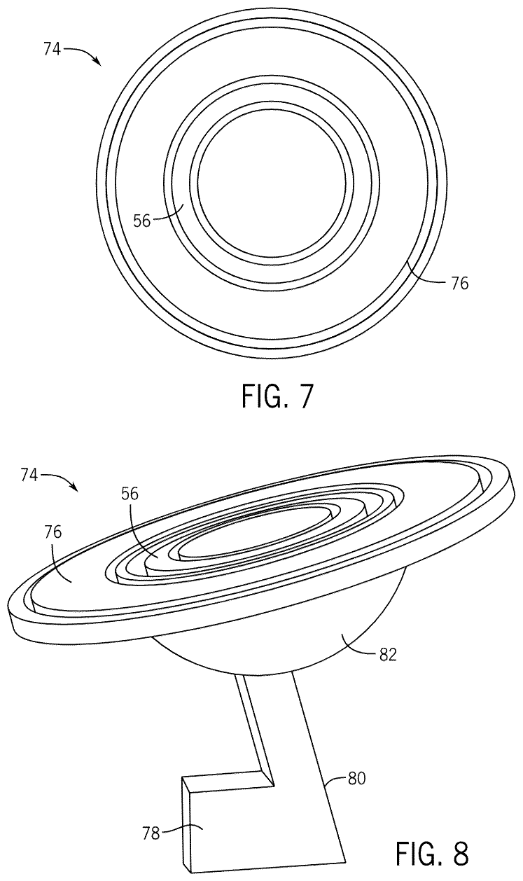

Referring to FIGS. 6 and 7, the housing 58 of the base unit 12 may include an aperture 72 sized to receive a support member 74. The support member 74 may couple to the drive shaft 70 within the housing 58 and extend above the housing 58 through the aperture 72. In some configurations, the support member 74 is configured to couple the base unit 12 to the container 14. A support surface 76, disposed on a top of the support member 74 and shaped to receive a bottom of the container 14, may include the electromagnet 56. As described further below, when activated, the electromagnet 56 may couple the support surface 76 to the ferromagnetic plate 34 disposed on the bottom of the container 14.

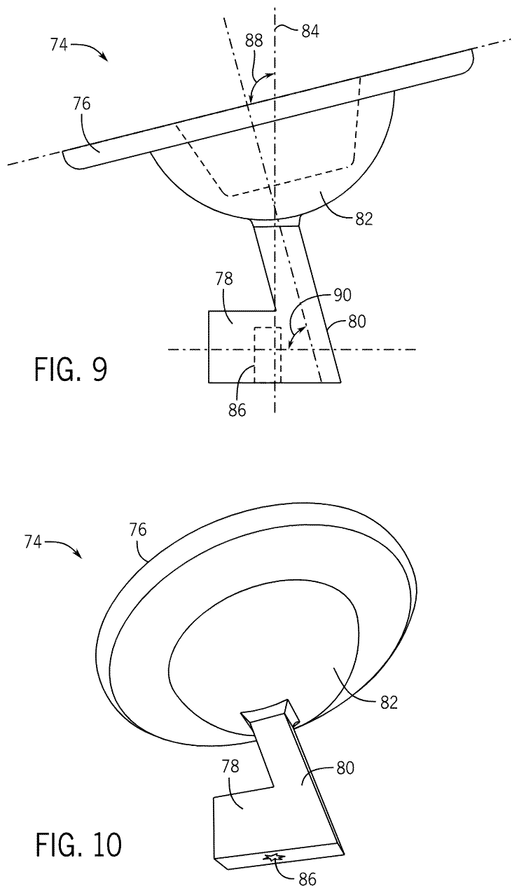

FIGS. 8-11 illustrate an example support member 74 that connects the drive shaft 70 to the container 14. The support member 74 may include a base arm 78 forming a bottom of the support member 74, and a platform arm 80 extending upward from the base arm 78 to a semi-sphere 82 extending below the support surface 76. The support member 74 includes a vertical axis 84 passing through a center of the support surface 76. A shaft receptacle 86, configured to receive the drive shaft 70, may be formed in a bottom surface of the base arm 78. A center of the drive shaft 70 may include a vertical axis of rotation. The shaft receptacle 86, and the vertical axis of rotation, may be off set from the vertical axis 84 such that rotation of the drive shaft 70 on the vertical axis of rotation may create a nutating movement of the support surface 76 and the container 14.

As illustrated in FIG. 10, an angle 88 between the support surface 76 and the vertical axis 84 may be non-transverse. In some configurations, the angle 88 between the support surface 76 and the vertical axis 84 may be between 92 and 145 degrees. In some configurations the angle 88 between the support surface and the vertical axis 84 may be dictated by an angle 90 between the platform arm 80 and the base arm 78. In some configurations, the angle 90 between the platform arm 80 and the base arm 78 may be non-transverse. The angle 88 between the support surface 76 and the vertical axis 84 may affect the amount of tumbling and mixing of the food items within the container 14.

As described above, the container 14 may be mounted to the support surface 76 that is positioned at the angle 88 that is non-transverse to the vertical axis 84. Also as described above, the shaft receptacle 86 that couples the support member 74 may be offset from the vertical axis 84. In some configurations, as the drive motor 52 rotates the support member 74 around the offset shaft receptacle 86, the container 14, attached to the angled support surface 76, may move in a motion path that can be nutation, orbital, rotational or some combination thereof.

Many traditional food mixers, mix or otherwise blend food ingredients using a stationary substantially vertical mixing container and a rotating arm disposed within the mixing container, configured to mechanically push the food ingredients around an inner volume of the mixing container. In some disadvantageous instances, the rotating arm of the traditional food mixer may cause damage to the food ingredients, for example, by breaking a breaded coating from a fried or otherwise cooked food item. In other disadvantageous instances, the rotating arm may force the food ingredients against a wall of the container that is not reachable by the rotating arm. In such examples, the traditional food mixer may require the kitchen staff to continuously push the food item toward a middle of the mixing container, ultimately requiring the kitchen staff to spend valuable time supervising the food mixing process. In still other instances, traditional food mixers may utilize a substantially vertical mixing container that rotates about an axis to mix or otherwise blend food ingredients. In such examples, centrifugal force may cause the food ingredient to stick to a wall of the mixing container, also requiring the kitchen staff to continuously push the food item toward a middle of the mixing container.

The illustrated configuration of the support member 74 in FIGS. 7-10 is designed to create a nutation movement path such that the base unit 12 and the container 14 act as a nutating mixer. In such a nutation movement path, the nutating movement of the container 14 may cause the food items to continuously tumble, as gravity causes the second food ingredient(s), displaced by centrifugal force, to tumble down the incline created by the angle 88 between the support surface 76 and the vertical axis 84. As the second food ingredient(s) continuously tumble and mix within the container 14, the first food ingredient may evenly coat the second food ingredient, resulting in a higher quality final product.

As described above, the electromagnet 56 may couple the support surface 76 to the ferromagnetic plate 34 disposed on the bottom of the container 14. The electromagnet 56 may be energized to create a magnetic field that may couple the ferromagnetic plate 34 to the support surface 76. Inversely, the electromagnet 56 may be de-energized, to turn off the magnetic field, and decouple the ferromagnetic plate 34 from the support surface 76. In this manner, the container 14 may be secured to the support surface 76 while mixing the food and then be released to allow the food item to be plated and served to customers.

Though it is contemplated that the electromagnet 56 can be replaced by a permanent magnet, the use of the electromagnet 56 may allow for easier coupling and decoupling of the support surface 76 and the ferromagnetic plate 34. In contrast to the permanent magnet, the magnetic field of the electromagnet 56 can be turned off, allowing kitchen staff to easily remove the container 14 from the base unit 12. When using the permanent magnet, kitchen staff may be required to exert a sufficient amount of force to overcome the magnetic force coupling the permanent magnet to the ferromagnetic plate 34. In such examples, the maximum strength of the permanent magnet that can be used, may be limited by the strength of the kitchen staff operating the system 10. Conversely, the strength of the magnetic attraction of the ferromagnetic plate 34 to the electromagnet 56 may be modulated by varying the current supplied to the electromagnet 56. In this manner, the electromagnet 56 may generate an increasingly strong magnetic field in response to an increasing supply of current, allowing the base unit 12 to nutate or otherwise move the container 14 at any speed without risk of uncoupling.

As described above, the base unit 12 may include the sensor 54. In some configurations, the base unit may include more than one type of the sensor 54. As described above, the sensor 54 may be utilized to sense a presence of the container 14 and/or an amount of the first food ingredient or second food ingredient disposed in the container 14. The placement of the container 14 on the support surface 76 may allow the ferromagnetic plate 34 to induce a flow of current through the electromagnet 56. In some configurations, the sensor 54 may be configured to sense the presence of a current flowing through the electromagnet 56 to determine the presence of the container 14 on the support surface 76. In some configurations, the sensor 54 may be a weight sensor, configured to sense a weight on top of the support surface 76. In some configurations, the sensor 54 may be attached to the drive motor 52, configured to sense a weight on top of the support surface 76 based on a load across the drive motor 52 during rotation of the drive shaft 70.

Referring again to FIG. 1, as described above, the dispenser 16 may be positioned in the first recess 36 of the docking station 18 and the base unit 12 may be positioned in the second recess 38 in the platform 40 of the docking station 18. Once connected to the power supply 22, the dispenser 16 may be ready to operate to dispense the first food ingredient (e.g., a sauce, topping, dressing or other liquid food) product onto the second food ingredient in the container 14. Furthermore, the control unit 24 of the dispenser 16 may be in electrical communication with the base unit 12 to operate and control the drive motor 52 and the electromagnet 56. As described above, in some configurations, the base unit 12 may include a separate control unit and power supply capable of separately operating and controlling the drive motor 52 and the electromagnet 56.

Still referring to FIG. 1, the container 14 may be filled with the second food ingredient and placed onto the support surface 76 of the base unit 12. In some configurations, the container 14 may not be filled with the second food ingredient until after the container 14 is placed onto the support surface 76. In some configurations, the kitchen worker may interact with the control panel 28 or with the power button 66 disposed on the base unit 12 to activate the electromagnet 56 and couple the support surface 76 to the ferromagnetic plate 34 disposed on the container 14. In some configurations, the kitchen staff worker may only activate the electromagnet 56 via the power button 66 or the control panel 28 once the sensor 54 senses the presence of the container 14 on the support surface 76. In some configurations, the presence of the container 14 on the support surface 76, sensed by the sensor 54, may automatically activate the electromagnet 56.

As described above, the control panel 28 may allow the kitchen worker to select a quantity of the first food ingredient to be dispensed. In some configurations, the control panel 28 may allow the worker to select a volumetric quantity of the first food ingredient (e.g., 1 ounce, 2 ounces, 3 ounces, 4 ounces, etc.). In some configurations, the kitchen worker may input to the control panel 28 a size of the second ingredient in the container 14 (e.g., 5 piece, 10 piece, 15 piece; S, M, L), a type of the second ingredient (e.g., boneless wings, traditional wings, vegetable wings, or other food), a type of the first ingredient to be dispensed, and/or other information that is pertinent to the amount of the first ingredient to be dispensed by the dispenser 16. The control unit 24 may store a volumetric quantity of the first food ingredient to be dispensed for each combination of options input into the control panel 28. For example, an input of an order of 10 boneless wings coated in barbecue may cause the control unit 24 to activate the pump assembly 26 to dispense 4 ounces of barbecue sauce into the container 14.

As described above, the control panel 28 may include the option to allow the system 10 to automatically determine an amount of the second food ingredient present in the container 14. As described above, the sensor 54 may determine a weight on top of the support surface 76. In some configurations, the control unit may calculate an amount of the second food ingredient present in the container 14 based on the weight determined by the sensor 54. The control unit 24 may then calculate an amount of the first food ingredient to be dispensed, based on the amount of the second food ingredient in the container 14.

In some configurations, the control panel 28 may include a manual dispense button that when pressed causes the pump assembly 26 to begin pumping the first food ingredient into the container 14 until the manual dispense button is released. The manual dispense button may be useful when a customer requests an extra amount of the first food ingredient.

Once the container 14 is filled with the second food ingredient, coupled to the base unit 12, and a desired amount of the first food ingredient determined, the pump assembly 26 may pump the desired amount of the first food ingredient into the container 14. In some configurations, the pump assembly may not pump the first food ingredient unless the sensor 54 senses the presence of the container 14. In some configurations, the container 14 may be stationary while the pump assembly 26 pumps the first food ingredient. In some configurations, the drive motor 52 may rotate, nutate, or otherwise spin the container 14 while the pump assembly 26 pumps the first food ingredient into the container 14, to allow for better initial distribution of the first food ingredient over the second food ingredient.

In some configurations, the ingredients may be mixed in the container 14 for a pre-set amount of time. In some configurations, the pre-set amount of time may be dictated by the type of the first food ingredient, the type of the second food ingredient, the amount of the first food ingredient, and/or the amount of the second food ingredient. In some configurations, a speed of the drive motor 52 may stay relatively consistent over the pre-set amount of time. In some configurations, a speed of the drive motor 52 may vary over the pre-set amount of time. For example, the drive motor 52 may initially rotate at a higher speed to urge the food items to begin mixing/tumbling within the container 14. Once the mixing begins, the speed of the drive motor 52 may be reduced and the mixing process may continue for the pre-set amount of time. It is contemplated that the control unit 24 may include one or more preset or programmable spinning profiles that may vary based on the type and amount of the first food ingredient and the second food ingredient.

During the mixing process, the electromagnet 56 may remain active such that the container 14 may not be easily removed from the base unit 12. Once the period of mixing is over, the electromagnet 56 may be deactivated to allow the container 14 to be removed. In some configurations, the electromagnet 56 may be automatically deactivated once the mixing period is over. In some configurations, the electromagnet 56 may be deactivated by the kitchen worker through interaction with the control panel 28 or with the power button 66.

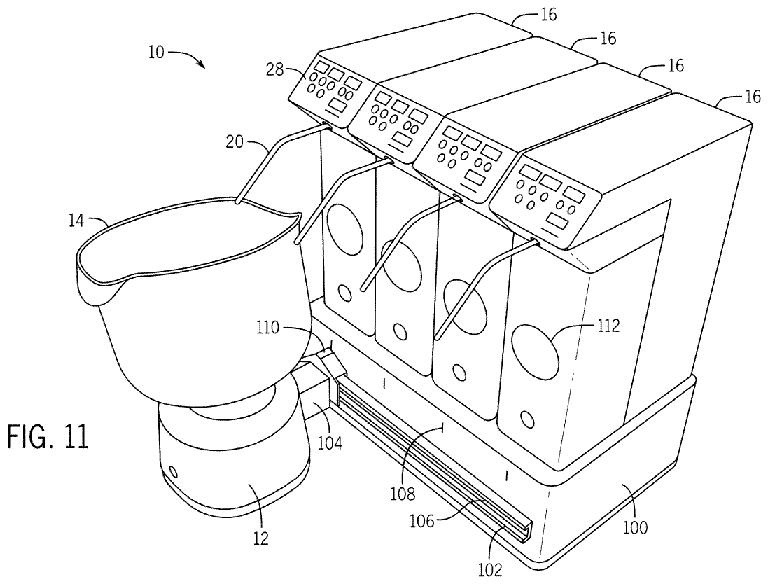

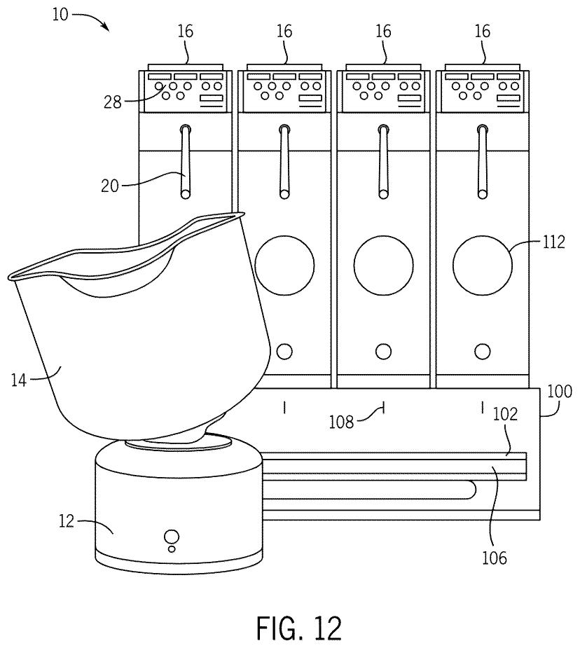

FIGS. 11 and 12 illustrate a configuration that includes four of the dispensers 16 supported on an expanded docking station 100. In some configurations, the expanded docking station 100 may include a power supply that provides power to the four dispensers 16 as well as power to the base unit 12. The expanded docking station 100 may include a rail 102 disposed on a front of the expanded docking station 100, configured to receive a guide arm 104. The guide arm 104 may connect the base unit 12 to the rail 102. The guide arm 104 may be moveable along the rail 102. In some configurations, the base unit 12 may roll on the wheels 46 or otherwise slide as the guide arm 104 moves side to side along the rail 102.

In some configurations, the rail 102 may include a plurality catches 106 configured to lock the guide arm 104 in position on the rail 102. One of the plurality of catches 106 may be aligned with each of the dispensing spouts 20 extending from the dispensers 16 on the extended docking station 100. The catches 106 may improve stability of the base unit 12 during mixing of the food ingredients. In some configurations, the kitchen worker may interact with the control panel to activate an arm magnet in the guide arm 104. The arm magnet may secure the guide arm 104, preventing movement of the base unit 12 along the length of the rail 102. The arm magnet may further improve stability of the base unit 12 during mixing of the food ingredients

In some configurations, the rail 102 may include a plurality of indicator lines 108. One of the plurality of indicator lines 108 may be aligned with each of the dispensing spouts 20 extending from the dispensers 16 on the extended docking station 100. The guide arm 104 may further include a pointer 110. The pointer 110 may align with the indicator lines 108 to communicate to a user that the base unit 12 is aligned with one of the dispensing spouts 20. In this manner, a worker can move the base unit 12 and container 14 into the proper position in front of the dispenser 16 that includes the desired sauce for the order being filled by the worker.

In some configurations, the base unit 12 may be moved along the rail 102 by a motor (not shown). In some configurations, the motor may be disposed in the base unit 12 and may be configured to drive the base unit along the rail 102 via the wheels 46. In some configurations, the motor may be disposed in the expanded docking station 100, configured to move the base unit 12 along the rail 102 via the guide arm 104. The motor may move the base unit 12 to align the container with the desired sauce for the order being filled. In some configurations, the motor may be controlled by the kitchen worker via interaction with the control panel 28. In some configurations, the motor may automatically position the base unit 12 in front of the dispenser that includes the desired first food ingredient.

In some configurations, the extended docking station 100 may include a position sensor (not shown). The position sensor may communicate a location of the base unit 12 or the guide arm 104 along the rail 102 to the control unit. The control unit 24 may therefore monitor the position of the base unit 12 as the motor moves the base unit 12 along the rail 102 to align with the dispenser 16 that includes the desired first food ingredient.

Once the base unit is aligned with the desired dispenser 16, the kitchen worker may follow a process similar to that described above to dispense and mix the food ingredients. In some configurations, the kitchen worker may dispense multiple types of the first ingredient from the multiple dispensers, before activating the drive motor 52 of the base unit 12.

In some configurations, the extended docking station 100 may fully automate the dispensing of the first food ingredient and the mixing of the first food ingredient and the second food ingredient. The extended docking station 100 may receive an order to a controller (not shown) of the extended docking station 100. Once the kitchen worker places enough of the second food ingredient in the container 14 to satisfy the order and couples the container 14 to the base unit 12, the controller may move the base unit 12 along the rail 102 via the motor. The controller may position the base unit 12 in front of the dispenser 16 having the requested first food ingredient and actuate the pump assembly 26 of the selected dispenser 16 to pump an amount of the first food ingredient into the container 14. The base unit 12 may mix the first and second ingredients in the container 14 for a pre-set amount of time. The kitchen worker may plate the order, having applied little effort and having wasted minimal time in the mixing of the food ingredients.

Each of the dispensers 16 may include an indicator 112 that indicates the type of first food ingredient in the dispenser 16. As illustrated, four of the most popular first food ingredients can be grouped together on the expanded docking station 100. In some embodiments, the restaurant may have sixteen or more separate sauces such that four of the expanded docking stations 100 could be used for the sixteen different sauces.

It is further contemplated that there may be one or more sauces that are dispensed at a greater regularity than other sauces. In such a situation, the most popular sauces could have a dedicated system such as that illustrated in FIG. 1 while less popular sauces could be grouped together as illustrated in FIGS. 11 and 12.

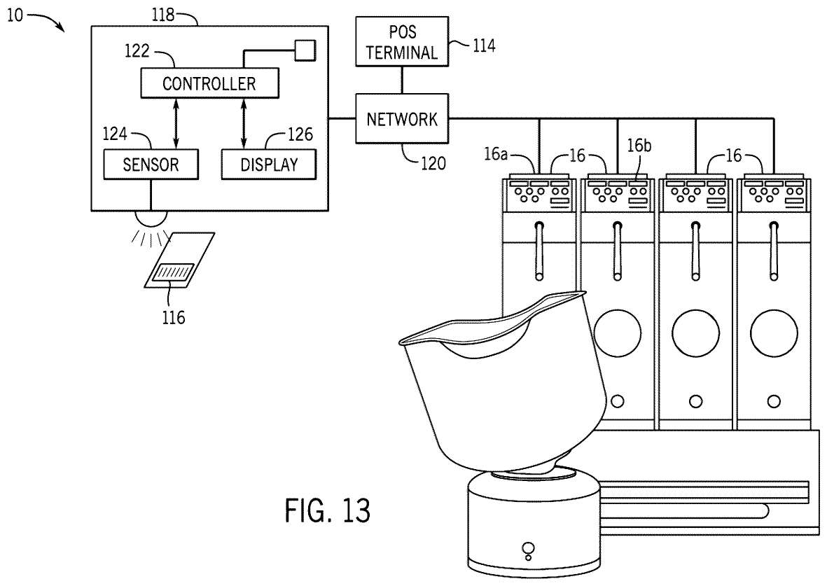

FIG. 13 illustrates a point of sale (POS) ordering terminal 114. In some configurations, an employee may receive an order from a customer and enter the order into the POS terminal 114. It is further contemplated that the POS terminal 114 could be an automated, unmanned terminal that allows the customer to enter an order from a touch screen, from a user-owned device, or an online ordering platform and subsequently pay for the order using any one of multiple payment procedures, such as a credit card, debit card, or cash. In each case, the point of sale (POS) terminal 114 may generate an order number or order ticket 116 that is used to track the food items that are going to be custom created for the customer. The order number/ticket could be represented in a variety of ways, such as through a QR code or a barcode. The order number, QR code, or barcode may include all of the details of the food items ordered by the customer at the POS terminal 114. In some configurations, the order number, QR code, or barcode generated by the POS terminal 114 may indicate one or more food items that each include one or more first food ingredients coating a second food ingredient.

As illustrated in FIG. 13 the POS terminal 114, a starting point device 118, and one or more dispensers 16 may be connected via a network 120 consisting of either a hardwire connection, a Wi-Fi connection, or Bluetooth® connection. The starting point device 118 may include a controller 122 that is in communication with a point sensor 124. The point sensor 124 can be an optical sensor that is operable to detect and read one of the codes on the order ticket 116 associated with the food item ordered at the POS terminal 114. The point sensor 124 may read the item code to obtain information regarding the one or more food items of the order. In some configurations, the POS terminal 114 may instead communicate the food item to the starting point device 118 via the network 120. Pending or in progress orders may be displayed on a display 126 of the starting point device. The display 126 may be a touch screen that allows the restaurant staff member to enter information into the starting point device 118 or generally interact with the starting point device 118.

The controller 122 within the starting point device 118 may control an automated process of guiding the kitchen worker to assemble the food or beverage item specified by the order ticket 116. The guided automated process may use one or indicators (e.g., LEDs, display screens, etc.) disposed on the dispensers 16 to guide the worker through the process. If the assembly sequence for the food item is important for the proper creation of the food or beverage item, the controller 122 can sequentially activate the indicators for the components such that the components are added in a desired order. Alternatively, if the sequence of adding the components to the food product is not important, all of the indicators could be simultaneously activated and the staff member may then add the components in the order that reduces movement or is the easiest to complete.

In some configurations, the dispenser 16 having the ordered first food ingredient item may illuminate one of the indicators. The worker may assemble an amount of the second food ingredient in the container 14 and bring the container 14 to the dispenser 16 having the illuminated indicator. The dispenser 16 having received the order via the network 120, may then automatically dispense an amount of the first food ingredient and mix the food ingredients in the container 14 via the base unit 12.

In some configurations, once the worker has assembled the amount of the second food ingredient in the container 14, the dispenser 16 may prompt the worker to select an option on the control panel 28 by illuminating one of the indicators disposed on, behind, or near the option. The dispenser 16 may similarly prompt the worker to select further options until the guided process is complete. The selected options may activate the electromagnet 56, activate a motor to translate the base unit 12, select an amount of the second food ingredient in the container 14, dispense an amount of the first ingredient, activate the drive motor 52 to mix the food ingredients, deactivate the electromagnet, etc.

As an illustrative example, the food item may be a 10-piece boneless barbeque wing. The kitchen worker may first fill the container 14 with 10 boneless wings. As the order requires barbecue, a first LED on a first dispenser 16a, including barbecue, may light up. The worker may then couple the container 14 to the base unit 12 in front of the first dispenser. The first dispenser 16a may then dispense a pre-set amount of barbecue sauce, and the base unit 12 may nutate, rotate, or otherwise mix the wings and the barbecue sauce within the container.

As another illustrative example, the food item may be a 10-piece boneless barbeque wing. The kitchen worker may first fill the container 14 with 10 boneless wings. As the order requires barbecue, a first LED on a first dispenser 16a, including barbecue, may light up. The worker may then place the container 14 having the ordered amount of the second ingredient onto the support surface 76. Once the container 14 is placed, an electromagnet LED may illuminate, proximate an electromagnet activation button. Selecting the electromagnet activation button may activate the electromagnet 56. Once the electromagnet 56 is activated, a dispensing LED may illuminate proximate the barbecue sauce button. Selecting the barbecue sauce button may dispense an amount of barbecue sauce. Once the barbecue sauce is dispensed, a mixing LED may illuminate proximate the mixing button. Selecting the mixing button may activate the drive motor 52. The base unit 12 may nutate, rotate, or otherwise mix the wings and the barbecue sauce within the container 14. Finally, the electromagnet LED may again illuminate the electromagnet activation button, to prompt the worker to press the electromagnetic activation button to decouple the container 14 from the electromagnet 56.

In some configurations, the customer may order a food item with more than one sauce. As an illustrative example, the order may be a 10-piece boneless barbeque and buffalo wing. The kitchen worker may first fill the container 14 with 10 boneless wings. As the order requires barbecue, the first LED on the first dispenser 16a, including barbecue, may light up. The worker may then couple the container 14 to the base unit 12 in front of the first dispenser 16a. The first dispenser 16a may then dispense a pre-set amount of barbecue sauce, and the base unit 12 may nutate, rotate, or otherwise mix the wings and the barbecue sauce within the container. As the order requires buffalo, a second LED on a second dispenser 16b, including buffalo, may light up once the wings are coated in barbecue. The worker may then couple the container 14 to the base unit 12 in front of the second dispenser 16b. The second dispenser 16b may then dispense a pre-set amount of buffalo sauce, and the base unit 12 may nutate, rotate, or otherwise mix the barbecue wings and the buffalo sauce within the container 14.

In some configurations, the first dispenser 16a and the second dispenser 16b may be mounted on the extended docking station 100 and connected by the rail 102. In such configurations, the worker may first fill the container 14 with 10 boneless wings and then couple the container 14 to the base unit 12. The base unit 12 may be connected to the rail 102 by the guide arm 104 and slid between the first dispenser 16a and the second dispenser 16b either manually by the worker, or automatically by the motor. In a similar situation to above, the customer may order a 10-piece boneless barbeque and buffalo wing. As the order requires barbecue, the first LED on the first dispenser 16a, including barbecue, may light up. The worker may slide the base unit 12 to a position under the first dispenser 16a, and dispense barbecue into the container 14. As the order requires buffalo, the second LED on the second dispenser 16b, including buffalo, may light up. The worker may then slide the base unit to a position under the second dispenser 16b, and dispense buffalo into the container 14. The base unit may then nutate, rotate, or otherwise mix the barbecue sauce, the buffalo sauce, and the wings within the container 14. As described above, in some configurations, once the container 14 is coupled to the base unit 12, the extended docking station 100 may automatically move the base unit 12 along the rail 102, dispense the barbecue sauce and the buffalo sauce into the container 14, and then nutate, rotate, or otherwise mix the barbecue sauce, the buffalo sauce, and the wings within the container 14.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1.-20. (canceled)

21. A system for dispensing a plurality of food ingredients into a receptacle and mixing the plurality of food ingredients within the receptacle, the system comprising:
a housing;
a first nozzle coupled to the housing and configured to dispenser a first food ingredient;
a second nozzle coupled to the housing and configured to dispenser a second food ingredient; and
an agitator coupled to the housing, the agitator including a receiver positioned below at least one of the first nozzle and the second nozzle, the receiver configured to receive the receptacle, and a motor coupled to move the receiver relative to the housing.

22. The system of claim 21 further comprising:
a first pump that pumps the first food ingredient from the first nozzle; and
a second pump that pump the second food ingredient from the second nozzle.

23. The system of claim 22, further comprising a controller that is configured to:
operate the first pump to dispense the first food ingredient from the first nozzle,
operate the second pump to dispense the second food ingredient from the second nozzle, and
operate the motor of the agitator to move the receiver to cause mixing of the first food ingredient and the second food ingredient.

24. The system of claim 23, wherein the housing, the first nozzle, the second nozzle, and the agitator define a base unit.

25. The system of claim 24, further comprising:
a first reservoir positioned within the base unit and configured to store the first food ingredient, the first reservoir coupled to the first nozzle such that the first pump pumps the first food ingredient from the first reservoir to the first nozzle; and
a second reservoir within the base unit and configured to store the second food ingredient, the second reservoir coupled to the second nozzle such that the second pump pumps the second food ingredient from the second reservoir to the second nozzle.

26. The system of claim 24, wherein the base unit further comprises a securing system configured to secure the receptacle to the receiver.

27. The system of claim 26, wherein the securing system includes an electromagnet configured to couple the receptacle to the receiver.

28. The system of claim 21, further comprising an actuator system that is operable to change a position between the receiver and at least one of the first nozzle and the second nozzle.

29. The system of claim 28, wherein the actuator system includes a guide arm that moves the receiver relative to the first nozzle and the second nozzle.

30. The system of claim 21, wherein the agitator rotates the receiver about a vertical axis.

31. The system of claim 30, wherein the housing is a first housing that is directly coupled to the first nozzle and the second nozzle, and
wherein the agitator includes a second housing that is removably coupled to the first housing by a base, the agitator configured to rotate the receiver about the vertical axis in a nutating motion.

32. A combined countertop dispensing and mixing system, the system comprising:
a base unit including:
a dispensing system including a plurality of nozzles and a plurality of pumps to dispense a plurality of food ingredients from the plurality of nozzles,
a mixing system including a support surface and a motor coupled to the support surface to move the support surface,
a control panel configured to receive a user input, and
a control unit configured to control the dispensing system and the mixing system based on the user input at the control panel.

33. The system of claim 32, further comprising a sensor in communication with the control unit, the sensor configured to sense a container on the support surface.

34. The system of claim 33, wherein the base unit further including an actuator configured to change a distance between the plurality of nozzles and the support surface.

35. The system of claim 34, wherein the mixing system further includes a securing element configured to secure a receptacle to the support surface.

36. The system of claim 32, wherein the control unit is configured to at least one of:
operate the motor according to one or more preset or programmable mixing profiles based on a type or amount of a first food ingredient of the plurality of food ingredients and a second food ingredient of the plurality of food ingredients, and
operate the plurality of pumps to dispense the first food ingredient of the plurality of food ingredients based on the type or the amount of the second food ingredient of the plurality of food ingredients.

37. The system of claim 32, wherein the control unit is configured to communicate with an external device via a wired or wireless network.

38. A system for dispensing and mixing a plurality of condiments, the system comprising:
a plurality of dispensers configured to dispense the plurality of condiments, each of the dispenser of the plurality of dispensers including:
a reservoir configured to store a condiment of the plurality of condiments,
a dispensing spout, and
a pump configured to pump the condiment from the reservoir and out of the dispensing spout;
a mixer positioned below the dispensing spouts of the plurality of dispensers, the mixer including:
a support surface configured to support a receptacle that receives the condiments from the plurality of dispensers, and
a motor configured to rotate the support surface about a vertical axis to mix the condiments within the receptable;
a touch screen display configured to receive a user input; and
a control unit in communication with the touch screen display, the control unit configured to operate the plurality of dispensers to dispense at least two condiments of the plurality of condiments from the plurality of dispensers based on the user input, and to operate the motor to mix the at least two condiments within the receptacle.

39. The system of claim 38 further comprising an actuator system to change a distance between the support surface and at least one of the dispensing spouts of the plurality of dispensers,
wherein the control unit is configured to operate the actuator system based on the user input.

40. The system of claim 38, wherein each of the plurality of dispensers includes a dispenser housing and the mixer includes a mixer housing that is separate from the dispenser housings.
